(19) United States
(12) Patent Application Publication
(10) Pub. No.: US 2013/0062021 A1
(43) Pub. Date: Mar. 14, 2013

(54) SUNSCREEN WITH WINDOW ACCESS

(71) Applicants: Timothy J. Michel, Lindstrom, MN (US); Eric Goodman, Newport, MN (US); Ned H. Albert, Burnsville, MN (US)

(72) Inventors: Timothy J. Michel, Lindstrom, MN (US); Eric Goodman, Newport, MN (US); Ned H. Albert, Burnsville, MN (US)

(21) Appl. No.: 13/228,647

(22) Filed: Sep. 9, 2011

(51) Int. Cl. E04F 10/08; B23P 11/00

(52) U.S. Cl. 160/61; 29/428

(57) ABSTRACT

A sunscreen structure including a top supporting structure securable to the building at a location near a top of an area to be screened from the sun and at least one slat panel suspended from the top supporting structure. A lower standoff structure is securable to the building at a location below the top supporting structure and is releasably securable to the at least one slat panel. An operable support is coupled between the lower standoff structure and the slat panel. The slat panel is shiftable between a first position where the slat panel is secured to the lower standoff structure and a second position where a lower portion of the one slat panel is displaced outwardly away from the lower standoff structure and supported in the second position by the operable support.

### FIELD OF THE INVENTION

The invention relates generally to sunscreens and awnings, more particularly the invention relates to sunscreens to be installed over window wall systems.

### BACKGROUND

Awnings and sunshades are sometimes applied to building structures near fenestrations such as windows and doors. Modern glazing systems vary considerably in structure from more common windows and doors that have been used in structures for many years. Modern glazing systems commonly include insulated glass units set in permanently secured and unopenable window structures. Modern glazing systems commonly have much larger areas of glass with smaller supporting partitions between them.

Awnings and sunshades are commonly made from fabric. Awning fabric materials are not amenable to all applications. In climates where wind and snow loads can be high, fabric awnings can be damaged or destroyed by wind and snow loads. Accordingly, there is room for improvement in the sunscreen and awning arts.

### SUMMARY OF THE INVENTION

A sunscreen structure according to the invention generally includes straight sections and corner sections. Straight sections are adapted to be coupled to generally straight portions of a building structure having windows or other fenestrations. The corner sections are adapted to be coupled to the building at corner areas where windows generally continue to at or near the corners of the building.

The straight sections generally include a top support structure, a slat panel and lower standoff structure. Multiple straight sections may be installed side by side to cover the width of the windows on the building. Generally straight sections are approximately the width of the windows that they shade. The top support structure, according to the invention, is adapted to allow a linear straight application of the slat panels despite irregularities that may exist in the building structure. The top support structure generally includes a T bracket having a hinge supporting member and a mounting member. The hinge supporting member generally includes an outwardly extending support and a fixed hinge pin secured to an outward end of the outwardly extending support. The mounting member is a generally flat flange adapted to be secured to the wall of the building via, for example, fasteners passed therethrough.

The slat panel generally includes peripheral uprights and multiple generally horizontal slats joined together.

The peripheral uprights are peripherally located and run generally vertically. The uprights may be formed for example, from aluminum bar stock or aluminum extrusions. The uprights generally present a top-located horizontal adjustment slot and a bottom pin aperture.

The uprights also may include a keeper bracket securable at least partially overlapping the top horizontal adjustment slot during the installation process. The keeper bracket generally includes a flat piece of material such as aluminum bar stock having a circular aperture therein, which can be placed over the hinge pin of the T bracket to secure the upright to the T bracket and locate the hinge pin within the top horizontal adjustment slot. The keeper bracket may be secured to the uprights by fasteners such as machine screws or rivets.

The slats, according to an example embodiment of the invention, are aluminum extrusions having a generally rectangular cross section having long walls and short walls. According to an example embodiment of the invention, the aluminum extrusions have screws splines located generally centrally on the short walls of the extrusion. According to an example embodiment of the invention, the slats are milled at their ends to remove one long wall and two short walls while maintaining the front long wall intact. The milled out portion is sized to accommodate the uprights therein. The slats, according to an example embodiment of the invention, may be formed of aluminum extrusions that have been anodized with a clear coat anodizing or a colored anodizing as desired.

The lower standoff structure generally includes a standoff member adapted to be secured to a window frame extending generally perpendicularly outwardly therefrom. The lower standoff structure presents a generally vertically oriented engagement slot therein. The vertical oriented engagement slot is dimensioned to receive a coupling pin therethrough which can be passed into the bottom pin aperture of the upright.

The lower standoff structure also may include an operable support hingedly coupled thereto. The operable support may include two support members and an over center linkage joining the two support members. According to one embodiment of the invention, an inner support member is coupled to the lower standoff structure, an outer support member is coupleable to the upright of the slat panel and the over center linkage joins the inner support member to the outer support member.

The corner sections generally include uprights and corner slats. The uprights are similar or identical to the uprights used in the straight sections and accordingly will not be furthered described here.

The corner slats comprise a generally L shaped structure in most cases having equal length legs though the legs can be of unequal lengths. The corner slats are joined at the corners at a miter joint which is reinforced by an internal angle brace. Fasteners, such as screws or rivets, are used to secure the two corner members of corner slats to the internal angle brace.

Installation of the sunscreen structure according to the present invention includes securing the top support structure to the building above windows of the building. According to one embodiment of the invention, the mounting member of the T bracket is placed against the building surface and secured by fasteners passing therethrough. The hinge supporting member then extends outwardly and presents the hinge pin at the outward end thereof The slat panels are hingedly secured to the top support structure by placing the top horizontal adjustment slot of the uprights over the fixed hinge pins of the top supporting structure. The slat panels are then secured to the top supporting structure by the application of the keeper bracket over the hinged pin once the slat panels have been aligned in a straight line. Thus, the slat panels are suspended and their weight is supported by the top support structure. The lower standoff structure is secured to the building or the window frame by the standoff member, which is secured, according to the present invention, generally by fasteners passed therethrough into the window frame. The coupling pin is inserted through the vertical engagement slot and into the bottom pin aperture of the uprights of the slat panels. The coupling pin is free to move vertically in the vertical engagement slot to compensate for expansion and contraction of the uprights of the slat panels that may be caused by heat from the sun and cooling when the sun is not shining on the sunscreen structure. The operable support is secured to the lower standoff structure at a first end and to at least one upright of the slat panels at the second end.

The corner sections are secured to the top support structure similarly to the slat panels of the straight sections. The bottom end of the corner sections are secured to the lower standoff structures similarly to the straight sections. Because of the right angle configuration of the corner sections, corner sections are fixed and are not hinged at the top as are the straight sections.

When it is desired to access the windows behind the sunscreen, for example, for cleaning, the coupling pin is removed from the lower standoff structure and the lower end of the uprights by removing it from the bottom pin aperture. The straight sections can then be hingedly swung outwardly and the operable support extended to its over center position to hold the straight panels outwardly away from the window, thus permitting access to the window for glass cleaning and other maintenance. When the glass cleaning or other maintenance is done, the operable support can again be folded and the coupling pin inserted through the vertical engagement slot into the bottom pin aperture of the uprights thus securing the sunscreen structure in place again.

The sunscreen structure of the present invention has great strength to resist wind loads and snow loads that may be common in Northern environments.

While an over center linkage operable support is described herein, other types of operable supports may also be utilized according to the knowledge of one of ordinary skill in the art.

In addition to the use of anodized aluminum as a material for the sunscreen structure, the surfaces of the sunscreen structure may also be coated with paint, powder coated or finished in another fashion and with other materials known to those of skill in the art. Further, while aluminum has excellent qualities for the construction of the sunscreen structure according to the invention other materials may be used and the discussion of aluminum should not be considered to be limiting. Materials that can be used include but are not limited to steel, stainless steel, composite materials and plastics.

### BRIEF DESCRIPTION OF THE DRAWINGS

FIG. 1 is a front elevational view of a sunscreen installation according to an embodiment of the invention;

FIG. 2 is a side elevational view of a sunscreen installation according to an example embodiment of the invention;

FIG. 3 is another side elevational view of a sunscreen installation according to an example embodiment of the invention;

FIG. 4 is a cross sectional view of a sunscreen installation according to an example embodiment of the invention;

FIG. 5 is another cross sectional view of a sunscreen installation according to an example embodiment of the invention;

FIG. 6 is another cross sectional view of a sunscreen installation according to an example embodiment of the invention;

FIG. 7 is a detailed view of an upper support structure according to an example embodiment of the invention;

FIG. 8 is a detailed view of a lower standoff structure according to an example embodiment of the invention; and

FIG. 9 is a detailed view of a corner installation of sunscreen according to an example embodiment of the invention.

### DETAILED DESCRIPTION OF THE DRAWINGS

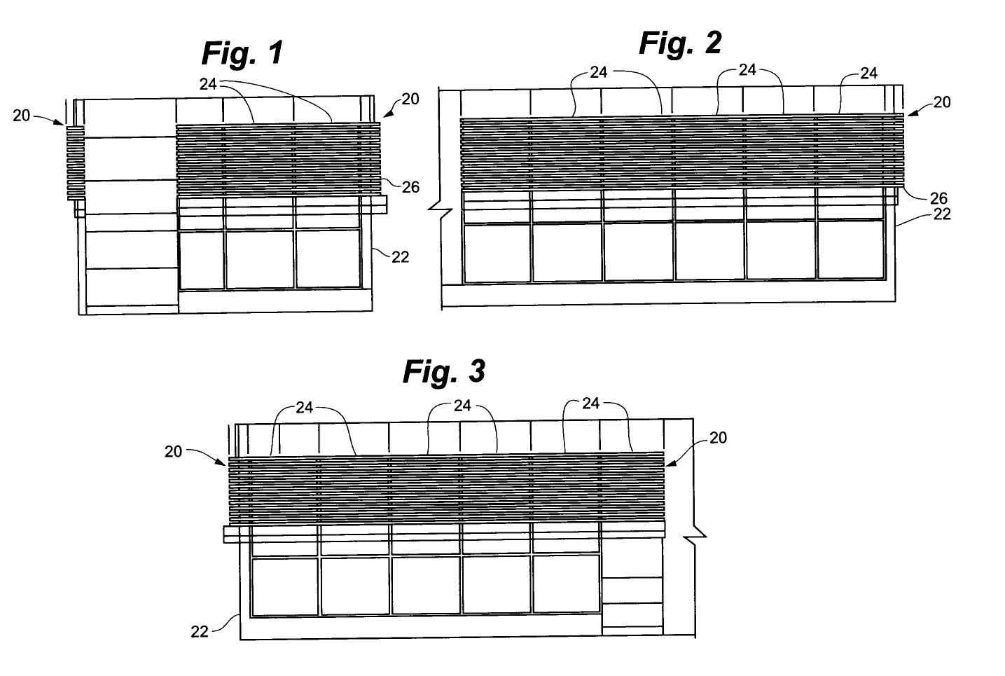

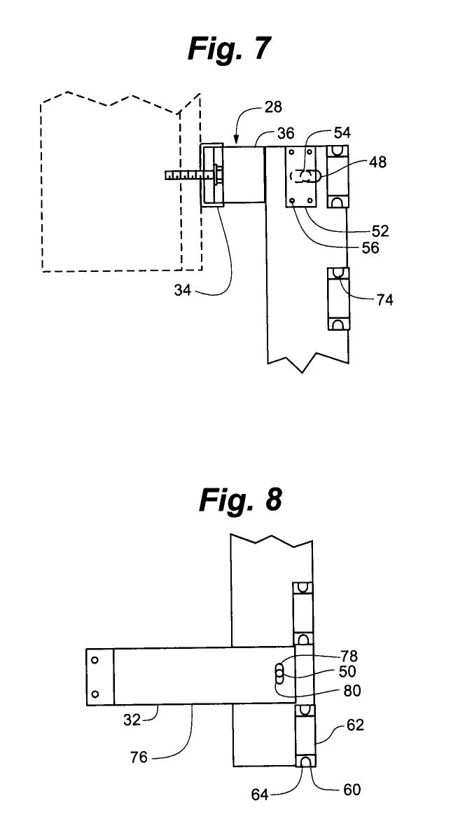

Referring to FIGS. 1-9, sunscreen structure 20 is generally installed secured to a building 22. Sunscreen structure 20 generally includes straight sections 24 and corner sections 26. The number of straight sections 24 will vary depending upon the length of the installation and size of the windows related to which the sunscreen structure is installed. A number of corner sections 26 will vary depending upon the number of corners of the building to be protected by the sunscreen structure.

Referring particularly to FIGS. 1-8, straight sections 24 according to an example embodiment of the invention, generally includes top support structure 28, slat panels 30 and lower standoff structure 32.

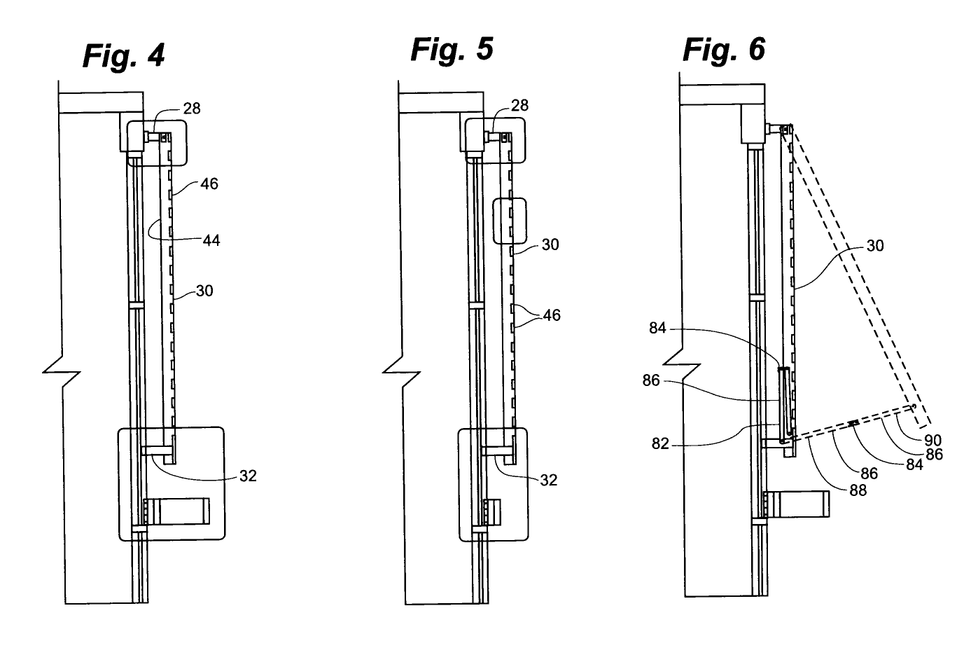

Referring particularly to FIGS. 4-7 and 9, top support structure 28 generally includes T bracket 34 having hinge supporting member 36 and mounting member 38. Hinge supporting member 36 generally includes outwardly extending support 40 and fixed hinge pin 42. Hinge supporting member 36 extends outwardly from mounting member 38 and is joined at a generally right angle thereto in the depicted example embodiment. Fixed hinge pin 32 is a generally cylindrical structure extending outwardly on both sides of outwardly extending support 40 fixedly secured thereto.

Slat panels 30 each generally include uprights 44 and slats 46.

In the depicted example embodiment, uprights 44 are generally peripheral located and vertically oriented in slat panels 30. Uprights 44 may be formed from a durable material such as metal. In particular, in one example embodiment, uprights 44 are formed from aluminum bar stock that has been anodized. Uprights generally present top horizontal adjustment slot 48 and bottom pin aperture 50.

Uprights 44 also include keeper bracket 52 which is secured thereto during the installation process. Keeper bracket 52 may be a generally rectangular plate structure having a circular aperture 54 sized to receive fixed hinge pin 32 therein. Keeper bracket also defines fastener holes 56. Keeper bracket 52 may be secured to uprights 44 by the application of fasteners (not shown) through fastener holes 56.

Slats 46 according to an example embodiment of the invention are formed by extrusions 58, extrusions 58 have a generally rectangular cross section including short sides 60 and long sides 62. According to an example embodiment of the invention, extrusions 58 also present screw splines 64 therein located generally centrally on the inside of short sides 60.

Slats 46 may be formed of an anodized aluminum alloy similar to uprights 44. According to one example embodiment of the invention, slats 46 are milled at peripheral ends 66 thereof. Milled portion 68 is formed so that one long sides 62 and two short sides 60 are removed in an area approximating the thickness of uprights 44. Accordingly, milled portions 68 presents front face 70, which is not affected by the milling process. Accordingly, front face 70 extends across the entire width of slats 46 while rear face 72 is shorter than front face 70 by approximately the combined thickness of two uprights 44.

Slats 46 are then secured to uprights 44 by fasteners (not shown) such as screws passed through screw aperture 74 of uprights 44 and into screw splines 64 of slats 66. Lower standoff structure 32 generally includes standoff member 76. Standoff member 76 is adapted to be secured to a window frame and generally presents vertical engagement slot 78 which is sized to receive coupling pin 80. Standoff member 76 also includes operable support 82.

In one example embodiment, operable support 82 generally includes over center linkage 84 and support members 86. Support members 86 includes inner support member 88 and outer support member 90 joined together by over center leakage 84. In this example embodiment, support members 86 generally include elongate structures with appropriate holes at each end to be joined to over center leakage 84 and to standoff member 76 as well as uprights 44.

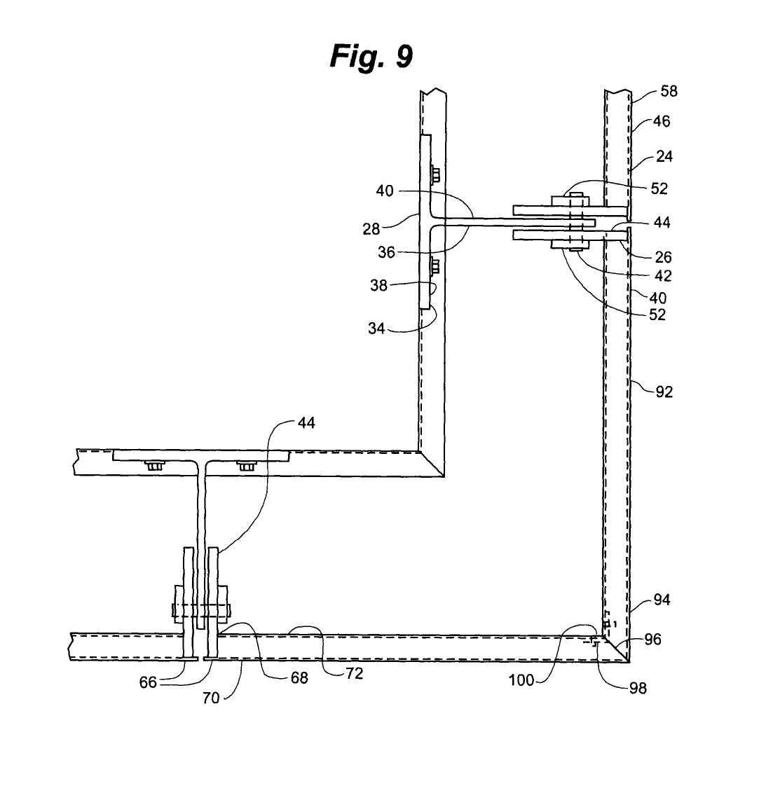

Referring particularly to FIG. 9, corner sections 26 generally include uprights 44 and corner slats 92. Corner slats 92 are generally L shaped structures in the depicted example having legs of equal length. Corner slats 92 are formed of similar extrusions 58 as slats 46. Corner slats 92 include milled portion 68 but only at one end thereof Corner portion 94 of corner slats 92 generally includes mitered end 96. Mitered end 96 in the example embodiment as depicted to include a 45° mitered, but this may be changed to accommodate corners of angles different than 90°. Corner slats 92 also presents at corner portion 94 internal angle brace 98 and in this example embodiment, fasteners 100. Two mirrored image mitered end 96 may be joined by inserting internal angle brace 98 therein and coupling fasteners 100 thereto.

Sunscreen structure 20 can be formed from parts made of anodized aluminum as discussed above. In addition, surfaces of the sunscreen structure 20 may also be coated with paint, powder coated or finished in another fashion and with other materials known to those of skill in the art. Further, while anodized aluminum has excellent qualities for the construction of sunscreen structure 20 according to the invention, other materials may be used and the discussion of aluminum in this application should not be considered to be limiting. Materials that can be used include but are not limited to steel, stainless steel, composite materials and plastics.

In operation, sunscreen structure 20 is secured to building 22 by attaching top support structure 28 to building 22.

Slat panels 30 are assembled by aligning slats 46 generally perpendicular to uprights 44 and passing fasteners, such as screws, through fastener holes 56 of uprights 44 into screw splines 64 of slats 46. As discussed above, front face 70 of slats 46 is longer than rear face 72 because of milled portion 68. Thus, front face 70 covers uprights 44 and extends slightly beyond uprights 44 presenting a clean appearance to the front of slat panels 30.

Corner sections 26 are assembled similarly at locations where uprights 44 meet corner slats 92. Corner portion 94 of corner slats 92 is assembled by inserting internal angle brace 98 into mitered end 96 and securing with fasteners 100.

Top support structure 28 is secured to building 22, typically by application by fasteners. T bracket 34 is secured to building 22 so that hinge supporting member 36 extends outwardly from building 22 in a generally perpendicular orientation. Each straight section 24 is supported between two T brackets 34 by the insertion of fixed hinge pin 42 into top horizontal adjustment slot 48. Once all of straight sections 24 are secured to fixed hinge pins 42 by placement of fixed hinge pins 42 within top horizontal adjustment slot 48 slat panels 30 may be aligned to compensate for any irregularity of building 22 to which top support structures 28 are attached. Upper portion of slat panels 30 may be aligned in a straight line such as by drawing a string across the fronts of the multiple slat panels 30 and moving top horizontal adjustment slots 48 relative to fixed hinge pins 42. After slat panels 30 are adjusted to be in a straight line orientation by the movement of top horizontal adjustment slot 48 relative to fixed hinge pin 42, keeper brackets 52 are secured to uprights 44 to keep slat panels 30 linearly aligned.

Lower stand off structure 32 is secured, for example, to a frame of the window be shaded, such as by fasteners. Lower stand off structure 32 may then be secured to one uprights 44 of a slat panel 30 or two uprights 44 of adjacent slat panels 30 by inserting coupling pin 80 through bottom pin aperture 50 of one upright through vertical engagement slot 78 of stand off member 76 and then through a second bottom pin aperture 50 of a second upright 44.

Operable support 82 is secured to standoff member 76 at a first end and to upright 44 at a second end. When it is desired to access windows covered by sunscreen structure 20, for example, for cleaning of glass, coupling pin 80 is removed and operable support 82 is extended to support straight sections 24 of slat panels 30 away from the windows to provide access. When access is no longer required, operable support 82 can be folded and coupling pin 80 reinserted to secure slat panels 30 to stand off member 76.

Referring to FIG. 9, corner sections 26, are secured to top support structure 28 by inserting fixed hinge pin 42 into top horizontal adjustment slot 48 of uprights 44 of corner sections 26. The lower portion of corner sections 26 are secured by passing coupling pin 80 through bottom pin aperture 50 of uprights 44 and into vertical engagement slot 78.

Corner sections 26 are generally secured without the ability to tilt them out because of their angular orientation.

Sunscreen structure 20 according to the present invention is highly durable and structurally designed to resist wind loads, snow loads and ice loads common in some environments.

The present invention may be embodied in other specific forms without departing from the spirit of the essential attributes thereof; therefore, the illustrated embodiments should be considered in all respects as illustrative and not restrictive, reference being made to the appended claims rather than to the foregoing description to indicate the scope of the invention.

1. A sunscreen structure, for attachment to a building having windows, the windows having window frames, the sunscreen structure comprising:
a top supporting structure securable to the building at a location near a top of an area to be screened from the sun;
at least one slat panel suspended from the top supporting structure, the slat panel including two upright members and a plurality of slat members oriented generally transverse to the upright members;
a lower standoff structure securable to the building at a location below the top supporting structure, the lower standoff structure being releasably securable to the at least one slat panel;
an operable support coupled between the lower standoff structure and the at least one slat panel; and
the at least one slat panel being shiftable between a first position wherein the at least one slat panel is secured to the lower standoff structure and a second position wherein a lower portion of the at least one slat panel is displaced outwardly away from the lower standoff structure and supported in the second position by the operable support.

2. The sunscreen structure as claimed in claim 1, wherein the top supporting structure comprises a hinge supporting member extending outwardly away from the building when installed.

3. The sunscreen structure as claimed in claim 1, further comprising a corner section having two of the upright members and corner slats joined to the upright members and oriented transversely to the upright members, each of the corner slats comprising a first straight portion and a second straight portion joined at an angle to each other.

4. The sunscreen structure as claimed in claim 1, wherein the lower standoff structure is coupled to the slat panel such the slat panel shiftable upwardly and downwardly relative to the lower standoff structure and substantially immobile inwardly and outwardly relative to the lower standoff structure.

5. The sunscreen structure as claimed in claim 4, wherein the lower standoff structure presents a vertically oriented slot through which a pin is coupled to the slat panel when the slat panel is secured.

6. The sunscreen structure as claimed in claim 1, wherein each slat member is formed from an extrusion having a rectangular cross section having two short sides and two long sides and presenting two screw splines located internally and generally centered on the two short sides.

7. The sunscreen structure as claimed in claim 1, wherein each slat member is formed from an extrusion having a rectangular cross section having two short sides and two long sides including a front long side and a back long side, each slat member having a front long side that extends outwardly and overlaps the upright members.

8. The sunscreen structure as claimed in claim 1, wherein at least some upright members include a top horizontal slot couplable to a hinge pin of the top supporting structure whereby alignment of the at least one slat panels may be adjusted.

9. The sunscreen structure as claimed in claim 8, further comprising a keeper bracket securable to the upright members whereby the alignment of the slat panels may be secured once adjusted.

10. A method of constructing a sunscreen structure for a building having windows, wherein the windows have frames, comprising:
securing a top supporting structure to the building at a location near a top of an area to be screened from the sun;
hingedly attaching at least one slat panel such that it is suspended from the top supporting structure, the slat panel including two upright members and a plurality of slat members oriented generally transverse to the upright members;
securing a lower standoff structure to the building at a location below the top supporting structure;
releasably securing the lower standoff structure to the at least one slat panel;
coupling an operable support between the lower standoff structure and the at least one slat panel such that the at least one slat panel is shiftable between a first position wherein the at least one slat panel is secured to the lower standoff structure and a second position wherein a lower portion of the at least one slat panel is displaced outwardly away from the lower standoff structure and supported in the second position by the operable support.

11. The method as claimed in claim 10, further comprising constructing a corner section having two of the upright members and corner slats joined to the upright members and oriented transversely to the upright members, each of the corner slats comprising a first straight portion and a second straight portion joined at an angle to each other and coupling the corner section to the top supporting structure.

12. The method as claimed in claim 10, further comprising coupling the lower standoff structure to the slat panel such the slat panel is shiftable upwardly and downwardly relative to the lower standoff structure and substantially immobile inwardly and outwardly relative to the lower standoff structure.

13. The method as claimed in claim 10, further comprising inserting a pin through a vertically oriented slot in the lower standoff into the slat panel.

14. The method as claimed in claim 10, further comprising forming each slat member from an extrusion having a rectangular cross section having two short sides and two long sides and presenting two screw splines located internally and generally centered on the two short sides.

15. The method as claimed in claim 10, further comprising forming each slat member to have a front long side that extends outwardly and overlaps the upright members.

16. The method as claimed in claim 10, further comprising adjusting at least some of the at least one slat panels by moving a top horizontal slot of the upright member relative to a hinge pin of the top supporting structure.

17. The method as claimed in claim 16, further comprising securing a keeper bracket to the upright members once the upright members are adjusted.
